(19) United States
(12) Patent Application Publication
(10) Pub. No.: US 2025/0299031 A1
(43) Pub. Date: Sep. 25, 2025

(54) ACCELERATING ARTIFICIAL NEURAL NETWORKS USING HARDWARE-IMPLEMENTED LOOKUP TABLES

(71) Applicant: AXELERA AI BV, Eindhoven (NL)

(72) Inventors: Martino Dazzi, Eindhoven (NL); Milos Stanisavljevic, Eindhoven (NL); Bram Verhoef, Eindhoven (NL); Evangelos Eleftheriou, Eindhoven (NL)

(21) Appl. No.: 19/112,412

(22) PCT Filed: Sep. 27, 2022
(86) PCT No.: PCT/EP2022/076848

§ 371 Date: Mar. 17, 2025

(51) Int. Cl. G06N 3/063; G06N 3/048

(52) U.S. Cl. CPC G06N 3/063; G06N 3/048

(57) ABSTRACT

The invention is notably directed to a hardware system (1) designed to implement an artificial neural network (ANN). The hardware system basically includes a neural processing apparatus (15), e.g., involving as crossbar array structure, one or more lookup table circuits (17), and one or more processing units (18). The neural processing apparatus is configured to implement M artificial neurons, where M≥1. The lookup table circuits are configured to implement a lookup table (LUT). The system further includes M′ processing units, where M≥M′≥1. Each processing unit is connected by at least one neuron, in order to be able to access a first value outputted by each connected neuron. In addition, each processing unit is connected to a LUT circuit, in order to efficiently access parameter values of a set of parameters from the LUT. Finally, each processing unit is configured to output a second value, corresponding to a value of a mathematical function taking said first value as argument. The mathematical function is otherwise determined by the set of parameters, the parameter values of which are accessed by each processing unit from the LUT, in operation. I.e., the mathematical function is defined (and thus determined) by a set of parameters, the values of which are efficiently retrieved from the hardware-implemented LUT. This results in a substantial acceleration of the computations of the function outputs, beyond the acceleration that may already be achieved within the neural processing apparatus and the processing units themselves. As a result, the neuron outputs can be more efficiently processed, prior to being passed to a next neuron layer. The invention is further directed to a method of operating such a hardware system.

### BACKGROUND

The invention relates in general to the field of in- and near-memory processing techniques (i.e., methods, apparatuses, and systems) and related acceleration techniques for executing artificial neural networks (ANNs). In particular, it relates to a hardware system including a neural processing apparatus (e.g., having a crossbar array structure) implementing neurons, processing units, and a hardware-implemented lookup table (LUT) storing parameter values, which are quickly accessed by the processing units to apply mathematical functions (such as activation functions) more efficiently to the neuron outputs.

ANNs such as deep neural networks (DNNs) have revolutionized the field of machine learning by providing unprecedented performance in solving cognitive data-analysis tasks. ANN operations often involve matrix-vector multiplications (MVMs). MVM operations pose multiple challenges, because of their recurrence, universality, compute, and memory requirements. Traditional computer architectures are based on the von Neumann computing concept, according to which processing capability and data storage are split into separate physical units. Such architectures suffer from congestion and high-power consumption, as data must be continuously transferred from the memory units to the control and arithmetic units through interfaces that are physically constrained and costly.

One possibility to accelerate MVMs is to use dedicated hardware acceleration devices, such as dedicated circuits having a crossbar array structure. This type of circuit includes input lines and output lines, which are interconnected at cross-points defining cells. The cells contain respective memory devices (or sets of memory devices), which are designed to store respective matrix coefficients. Vectors are encoded as signals applied to the input lines of the crossbar array to perform the MVMs by way of multiply-accumulate (MAC) operations. Such an architecture can simply and efficiently map MVMs. The weights can be updated by reprogramming the memory elements, as needed to perform the successive matrix-vector multiplications. Such an approach breaks the “memory wall” as it fuses the arithmetic- and memory unit into a single in-memory-computing (IMC) unit, whereby processing is done much more efficiently in or near the memory (i.e., the crossbar array).

While the main computational load of ANNs such as DNNs revolves around MAC operations, the execution of ANNs often involve additional mathematical functions, such as activation functions. Even in quantized neural networks, activation functions are needed, which are inherently harder to compress and often require to be performed in floating point precision.

In hardware platforms designed for efficient execution of DNNs and low-power consumption, executing such functions can be cumbersome and expensive in terms of computational resources, the present inventors concluded. One possible solution is to offload the execution of such functions to a digital signal processor (DSP). However, doing so can be very demanding in terms of latency, area, and energy.

Therefore, the present inventors took up the challenge to achieve a new computational architecture, involving non-conventional processing means, to accelerate the computation of such functions.

### SUMMARY

According to a first aspect, the present invention is embodied as a hardware system designed to implement an artificial neural network (ANN). The hardware system basically includes a neural processing apparatus, one or more lookup table circuits, and one or more processing units. The neural processing apparatus is configured to implement M artificial neurons, where M≥1. The one or more lookup table circuits are configured to implement a lookup table (LUT). The system further includes M′ processing units, where M≥M′≥1. Each processing unit of the M′ processing units is connected by at least one neuron of the M artificial neurons, so as to be able to access a value (referred to as a “first value”) outputted by each neuron of said at least one neuron, in operation. In addition, each processing unit is connected to a LUT circuit of the one or more LUT circuits, in order to be able to access parameter values of a set of parameters from the LUT, in operation. Finally, each processing unit is configured to output a value (a “second value”) of a mathematical function taking the first value as argument. The mathematical function is otherwise determined by the set of parameters. In operation, the parameter values of the set of parameters are accessed by said each processing unit from said LUT circuit.

The architecture of this hardware system differs from conventional computer architectures, where a same digital processor (or same set of digital processors) is typically used to both compute the neuron output values and apply the subsequent mathematical functions (e.g., activation functions). On the contrary, here, the processing hardware used to compute the neuron output values differs from the processing units used to apply the mathematical functions, although the processing units may well be configured, in the system, as near-memory processing devices. Such an architecture is adopted for computational efficiency reasons. In particular, the LUT is implemented in hardware, thanks to hardware circuits that differ from each of the neural processing apparatus (used to compute the neuron outputs) and the processing units (used to apply the mathematical functions). Substantial acceleration is achieved thanks to the hardware-implemented LUT. I.e., the mathematical function is defined (and thus determined) by a set of parameters, the values of which are efficiently retrieved from the hardware-implemented LUT. This results in a substantial acceleration of the computations of the function outputs, beyond the acceleration that may already be achieved within the neural processing apparatus and the processing units. As a result, the neuron outputs can be more efficiently processed, prior to being passed to a next neuron layer.

Moreover, little memory is required, given that the LUT stores parameter values instead of mapping input values to output values; the LUT is not used to directly look up the function outputs, contrary to what is usually done when using lookup tables.

Finally, the present approach is compatible with integration. In particular, the LUT circuits, the processing units, and the neural processing apparatus, can advantageously be co-integrated in a same device, e.g., on a same chip.

In embodiments, each processing unit is configured to output the second value by: (i) selecting said set of parameters in accordance with the first value; and (ii) performing operations based on the first value and the parameter values of the selected set of parameters, with a view to outputting the second value. This, in practice, makes it possible to reduce the number of parameters required, because a small set of parameters already suffices to accurately estimate the function, locally, over an interval containing each potential input value.

Preferably, each processing unit is further configured to select said set of parameters by comparing the first value with bin boundaries to identify a relevant bin, i.e., the bin that contains the first value. To that aim, each processing unit is further configured to access the bin boundaries from said lookup table circuit. The set of parameters are subsequently selected in accordance with the identified bin, in operation. Accordingly, the bin boundaries can be efficiently accessed, to enable quick comparisons. The binning problem can thus be efficiently solved, which makes it possible to quickly identify the relevant set of parameters.

In preferred embodiments, dedicated comparator circuits are used to efficiently identify the relevant bins. That is, each processing unit includes at least one comparator circuit. This circuit is designed to compare the first value with the bin boundaries and transmit a selection signal encoding the selected set of parameters. The processing unit can then access the corresponding parameter values, based on the transmitted signal.

A mere binary tree comparison circuit may be relied on. However, more sophisticated comparison schemes and comparison circuit layouts can be contemplated. The comparison circuit can notably be designed to enable multiple levels of comparison, to accelerate the binning. In particular, the comparator circuit may advantageously be configured as a multilevel, q-ary tree comparison circuit, which is designed to enable multiple levels of comparison, where q is larger than or equal to three for one or more of the multiple levels.

In embodiments, each LUT circuit is a circuit hardcoding the parameter values. In addition, each processing unit includes at least one multiplexer, which is connected, on the one hand, to a respective comparator circuit to receive the selection signal and, on the other hand, to a LUT circuit to retrieve the corresponding parameter values in accordance with the selection signal. Such a design makes the parameter retrieval extremely efficient. A downside is that the hardcoded data cannot be changed after hard-wiring the LUT circuit.

Thus, in variants, one may prefer using a reconfigurable memory. This way, the mathematical functions may be dynamically reconfigured as calculations proceed or updated, if necessary. For instance, each LUT circuit may include an addressable memory unit, which is connected to a comparator circuit to receive the selection signal. This way, the addressable memory unit can retrieve the parameter values of the set of selected parameters in accordance with the received selection signal.

In preferred embodiments, the mathematical function is a piecewise-defined polynomial function, which is polynomial on each of its sub-domains. The sub-domains respectively correspond to the bins. In this case, the selected set of parameters correspond to polynomial parameters of the piecewise-defined polynomial function. I.e., the selected set of parameters correspond to parameters of the locally-relevant polynomial. Such a construct lends itself well to fast computations by an arithmetic unit as simple arithmetic operations are needed to achieve the desired result. Thus, each processing unit may advantageously include an arithmetic unit, which is connected in output of a LUT circuit, whereby the operations needed to compute the second value are performed as arithmetic operations by the arithmetic unit.

Interestingly, such operations can simply be performed using a multiply-and-add circuit, i.e., a circuit specifically designed to efficiently perform multiply-accumulate operations. Thus, the arithmetic unit preferably includes a multiply-and-add circuit, which makes it possible to achieve the output value of the mathematical function more rapidly.

In preferred embodiments, the neural processing apparatus includes a crossbar array structure including N input lines and M output lines arranged in rows and columns, where N>1 and M>1, whereby the neural processing apparatus can implement a layer of M neurons. The input lines and output lines are interconnected via memory elements. Each of the M output lines is connected to at least one of the M′ processing units. A crossbar array structure fuses the arithmetic- and memory unit into a single, in-memory-computing unit, allowing the neuron outputs to be efficiently obtained.

The neural processing apparatus is typically designed to implement several neurons at a time (M>1). The number of neurons may for instance be larger than or equal to 256 or 512 (M≥256 or M≥512). Besides, the processing units can advantageously be vector processing units, where each of the M′ processing units is a vector processing unit including b processing elements, so as to be able to operate on a one-dimensional array of dimension b. The number M′ of processing units is preferably equal to 1 or 2.

Various architectures can be contemplated. For example, several processing units may be relied on (i.e., M′>1), although their number can typically be less than or equal to the number of neurons that can be implemented at a time (i.e., M≥M′>1). In such a case, the LUT circuits may include M′ distinct circuits, which are respectively mapped onto the M′ processing units.

According to another aspect, the invention is embodied as a method of operating a hardware system such as described above. I.e., the system provided includes a neural processing apparatus configured to implement M artificial neurons, where M≥1, as well as M′ processing units, each connected by at least one neuron of the M artificial neurons. The hardware system further includes one or more LUT circuits implementing a LUT. The method comprises operating the neural processing apparatus to obtain M first values produced by the M artificial neurons, respectively. In addition, the method relies on the M′ processing units to apply a mathematical function to the neuron outputs. That is, an output value of a mathematical function is obtained (via the M′ processing units) for each first value of the M first values. This mathematical function is otherwise determined by a set of parameters. So, the output value of this mathematical function is obtained based on operands that include the first value and parameter values of the set of parameters, where the parameter values are retrieved from the one or more LUT circuits.

Preferably, the output value is obtained, for said each first value, by selecting the set of parameters in accordance with the first value, and performing operations based on the first value and the parameter values retrieved in accordance with the selected set of parameters.

In preferred embodiments, the set of parameters are selected by comparing the first value with bin boundaries (retrieved from the one or more LUT circuits) to identify a relevant bin, which contains the first value. The set of parameters is then selected in accordance with the identified bin.

As noted above, the applied mathematical function is preferably a piecewise-defined polynomial function. In that case, each set of parameters includes two or more polynomial coefficients. The operations performed to compute the second value may be mere arithmetic operations. In preferred embodiments, the mathematical function involves a set of linear polynomials, each corresponding to a respective one of the bins. In this case, the set of parameters corresponding to each of the linear polynomials consists of a scale coefficient and an offset coefficient. Again, the arithmetic operations can advantageously be performed thanks to a multiply-and-add circuit.

In embodiments, the method further comprises programming the one or more LUT circuits implementing the LUTs, to enable one or more types of mathematical functions, e.g., an activation function, a normalization function, a reduction function, a state-update function, a classification function, and/or a prediction function.

The method may further include upstream steps (i.e., performed at build time, prior to operating the neural processing apparatus) to determine one or more sets of adequate bin boundaries, in accordance with one or more reference functions (i.e., mathematical functions of potential interest for ANN executions), respectively. In embodiments, bin boundaries are determined for each reference function, so as to minimize a number of the bins or a maximal error, where the error is measured as the difference between approximate values of each reference function as computed based on parameter values and theoretical values of that reference function.

### BRIEF DESCRIPTION OF THE DRAWINGS

These and other objects, features and advantages of the present invention will become apparent from the following detailed description of illustrative embodiments thereof, which is to be read in connection with the accompanying drawings. The illustrations are for clarity in facilitating one skilled in the art in understanding the invention in conjunction with the detailed description. In the drawings:

FIG. 1 schematically represents a computer network involving several hardware systems according to embodiments of the invention. The network allows a user to interact with a server, in order to accelerate machine learning computation tasks that are offloaded to the hardware systems, as in embodiments;

FIG. 2 schematically represents selected components of a hardware system, which notably includes a neural processing apparatus having a crossbar array structure, processing units, and a hardware-implemented lookup table (LUT), according to embodiments;

FIG. 3 is a diagram illustrating a possible architecture of a hardware system according to preferred embodiments, illustrating how neurons of the neural processing apparatus connect to vector processing units, and how the latter connect to LUT circuits;

FIG. 4 is a circuit diagram depicting a given processing element (e.g., of a vector processing unit such as shown in FIG. 3), connected to a respective LUT circuit, as in embodiments. In this example, the processing element involves a comparator and a multiplexer, and the lookup table is implemented by a circuit hardcoding parameter values needed to apply a mathematical function to the neuron outputs;

FIG. 5 is a variant to FIG. 4, in which the LUT circuit is now implemented as an addressable memory (no multiplexer is required in this example);

FIG. 6 is a flowchart illustrating high-level steps of a method of operating a hardware system such as shown in FIG. 2 or 3, in accordance with embodiments;

FIGS. 7A, 7B, and 7C are graphs illustrating how a nonlinear function can be approximated using a piecewise-defined polynomial function, thanks to optimized bin boundaries, as in embodiments; and

FIG. 8 is a table illustrating the optimisation of the number of comparators involved in each level of a multilevel, q-ary tree comparison circuit, as used in embodiments.

The accompanying drawings show simplified representations of devices or parts thereof, as involved in embodiments. Similar or functionally similar elements in the figures have been allocated the same numeral references, unless otherwise indicated.

Hardware systems and methods embodying the present invention will now be described, by way of non-limiting examples.

### DETAILED DESCRIPTION OF EMBODIMENTS OF THE INVENTION

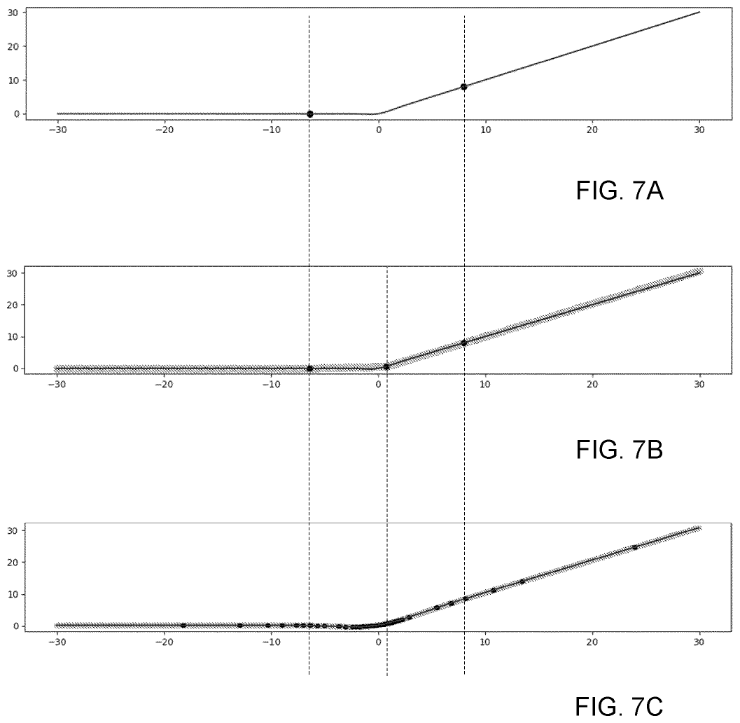

The following description is structured as follows. General embodiments and high-level variants are described in section 1. Section 2 addresses particularly preferred embodiments and technical implementation details. Section 3 compounds final remarks. Note, the present method and its variants are collectively referred to as the “present methods”. All references Sn refer to methods steps of the flowchart of FIG. 7, while numeral references pertain to devices, components, and concepts involved in embodiments of the present invention.

### 1. General Embodiments and High-Level Variants

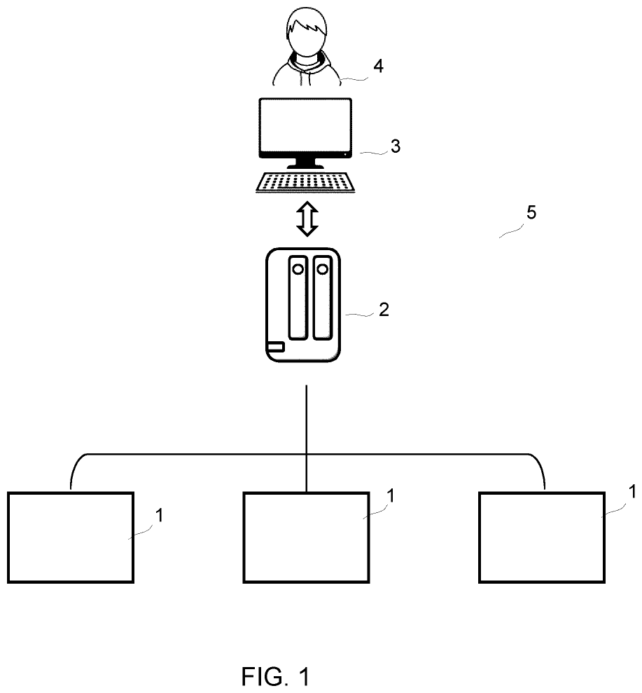

A first aspect of the invention is now described in detail, in reference to FIGS. 1-5. This aspect concerns a hardware system 1, also referred to as a “system” herein, for simplicity. The system 1 is designed to execute an artificial neural network (ANN) by efficiently evaluating mathematical functions (such as activation functions) that are applied to the neuron outputs.

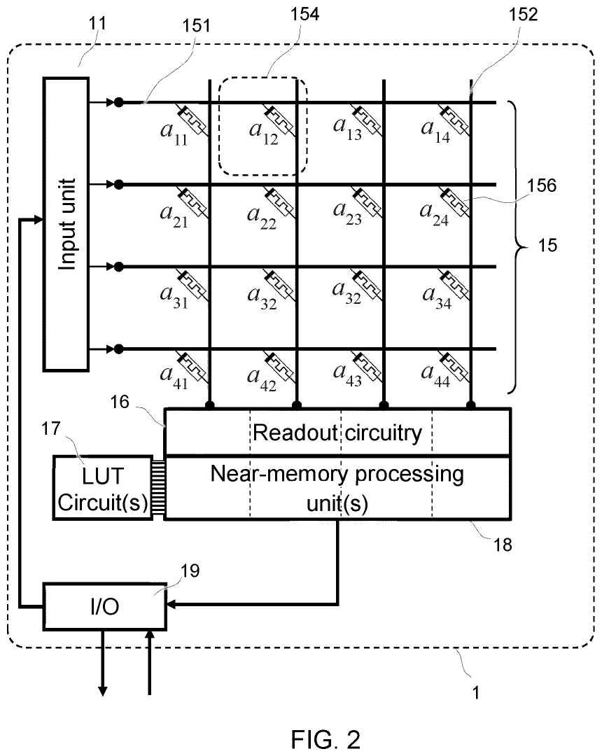

An example of such a hardware system 1 is shown in FIG. 2. The system 1 essentially includes a neural processing apparatus 15, a hardware-implemented lookup table (LUT) 17, and one or more processing units 18.

The neural processing apparatus 15 is configured to implement M artificial neurons, where M≥1. In practice, however, M will typically be strictly larger than 1. For example, the apparatus 15 may enable up to 256 or 512 neurons, possibly more. However, there can be circumstances in which the neural processing apparatus 15 may come to implement a single neuron at a time, as exemplified later. The neural processing apparatus 15 may advantageously have a crossbar array structure 15, as assumed in FIG. 2.

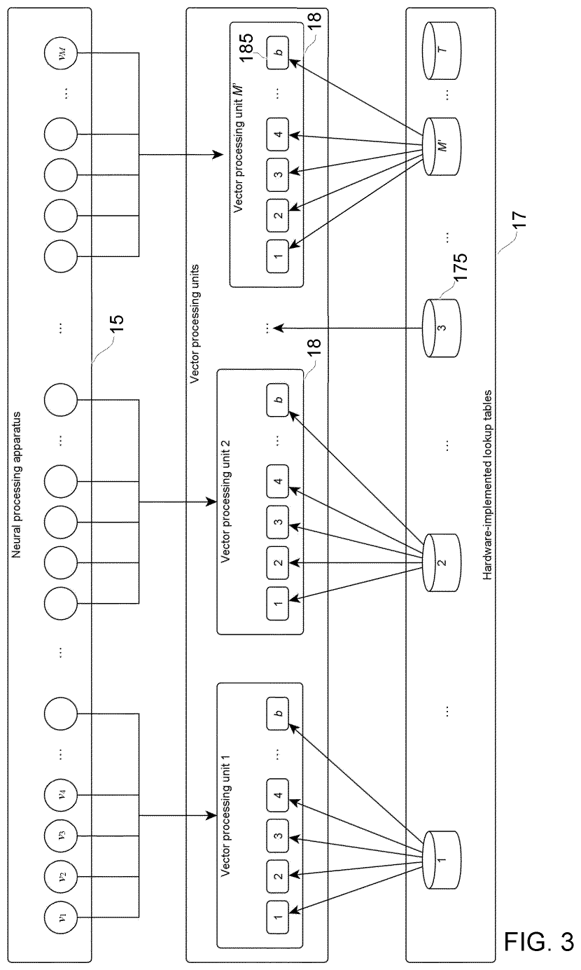

The LUT is implemented by way of one or more LUT circuits 175, as illustrated in FIG. 3. Several types of LUT circuits 175a, 175b can be contemplated, as discussed later in detail.

The system further relies on M′ processing units 18 to evaluate the mathematical functions, where M≥M′≥1. As shown in FIG. 3, each processing unit 18 may include several processing elements 185 and enable several effective processors.

As illustrated in FIGS. 2 and 3, the neurons connect to the processing units 18, which themselves connect to the LUT circuits. A variety of configurations can be contemplated. FIG. 3 illustrates a preferred architecture. A minima, each processing unit 18 is connected by at least one of the M neurons implemented by the apparatus 15. This way, each processing unit 18 can access neuron outputs, i.e., values outputted by at least one of the neurons, possibly more. In addition, each processing unit 18 is connected to one or more of the LUT circuits 175, 175a, 175b, in order to permit a fast computation of the second values. For example, each processing unit can be connected to a respective LUT circuit 175, as assumed in FIG. 3.

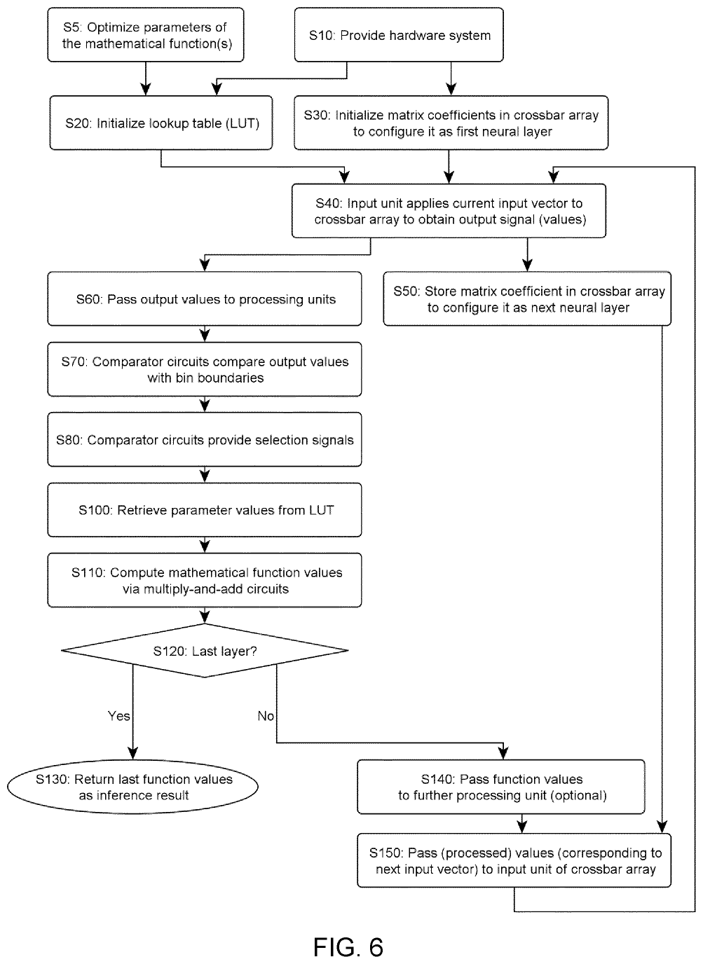

In the following, the neuron outputs are referred to as “first values”, as opposed to values outputted by the processing units 18, which are referred to as “second values”. A “first value” corresponds to one of M values outputted by the neurons, at each algorithmic cycle, whereas a “second value” corresponds to the value of mathematical function applied to this first value, as evaluated (i.e., computed) by a processing unit. Note, an algorithmic cycle is a cycle of computations triggered by the neural processing unit 15. Each algorithmic cycle starts with computations performed by this unit 15 (see step S40 in FIG. 6). In turn, each processing unit 18 is configured to access at least one first value (from a connected neuron) and output a second value, at each algorithmic cycle. Thus, M second values are outputted by the processing units, during each algorithmic cycle. Still, the number of available processing elements may possibly require several computation sub-cycles for the processing units to be able to output the M second values, inside each algorithmic cycle.

The first value is the argument of the applied function. In addition, in the present context, any mathematical function applied to a neuron output is further defined (and thus determined) by a set of parameters. The values of the function parameters are efficiently retrieved from the LUT, which, in turn, makes it possible to efficiently compute the values of the mathematical functions involved. Thus, one or more mathematical functions are applied to the neuron outputs, at each cycle, using a non-conventional hardware architecture.

The above specification of the system 1 defines minimal constraints as to the architecture of the processing unit(s) 18, LUT circuit(s) 17, and neural processing apparatus 15. Various embodiments can be contemplated. In addition, a number of concepts are relied upon, which are defined below.

Hardware architecture. The hardware system 1 includes several devices (i.e., one or more processing units 18, one or more LUT circuits 17, as well as a neural processing apparatus 15), which are connected to each other to form the system 1. However, the system 1 itself can be fabricated as a single apparatus or, even, as a single device. In particular, the LUT circuit(s) 17, the processing unit(s) 18, and the neural processing apparatus 15, may all be co-integrated in a same chip, as assumed in FIG. 2. Additional components may be involved, as discussed later in reference to FIG. 2.

In principle, the neural processing apparatus 15 can be any information processing apparatus 15 or information processing device that is capable of implementing artificial neurons of an ANN. The apparatus 15 performs basic functions inherent to ANN neurons. I.e., ANN neurons produce signals meant to other neurons, e.g., neurons of a next layer in a feed-forward or recurrent neural network configuration. However, such signals encode values that typically need post-processing (such as applying activation functions), hence the benefit of having processing units 18 connected to the neurons.

The neural processing apparatus 15 can possibly be a general- or special-purpose computer. Preferably, however, the processing apparatus 15 has a crossbar array structure 15 (also called “crossbar array”, or simply “crossbar” in this document). A crossbar array structure is a non-conventional processing apparatus, which is designed to efficiently process analogue or digital signals to perform matrix-vector multiplications, as noted in the background section. Relying on a crossbar array structure 15 already makes it possible to substantially accelerate matrix-vector multiplications, as involved during the training and inference phases of the ANN.

A crossbar array structure 15 enables M neurons at a time (where M>1) and can be used to implement a single neural layer (or a portion thereof) at a time. The neurons are denoted by v₁ . . . v_{M} in FIG. 3. In principle, M can be any number permitted by the technology used to fabricate the apparatus 15. Typically, the number M of neurons enabled by a crossbar is equal to 256, 512, or 1024. However, the problem to solve may possibly involve non-commensurate ANN layers, i.e., layers involving a different number of neurons than what is effectively permitted (at a time) by the crossbar 15. So, a distinction should be made between the number M of neurons actually enabled by the crossbar 15 at a time (which can be referred to as the physical neural layer) and the size of the abstract neural layers involved in the problem to be solved. In practice, however, such potential discrepancies are not an issue. Indeed, ANN layers of less than M neurons can be handled by the apparatus 15 outright, whereas ANN layers of more than M neurons can be mapped onto a crossbar 15, by repeatedly operating the latter. Thus, non-commensurate ANN layers can adequately be handled in practice. For completeness, crossbar array structures 15 as involved herein may generally be used to map neurons in a variety of ANN architecture, such as a feedforward architecture (including convolutional neural networks), a recurrent network, or a transformer network, for example.

A crossbar array structure 15 can be cyclically operated, in a closed loop, so as to make it possible for this structure 15 to implement several successive, connected neural layers of the ANN. In variants, several crossbar array structures 15 are cascaded, to achieve the same. The neural layer implemented by a crossbar array structure 15 can be any layer of the ANN (or portion thereof), including a final layer, which may possibly consist of a single neuron. Thus, in certain cases (e.g., during a final algorithmic cycle), the number of neurons effectively enabled by a crossbar array structure can be equal to 1.

The architecture of the hardware systems 1 differs from conventional computer architectures, where a single digital processor (or a single set of digital processors) is normally used to both compute the neuron output values and apply the subsequent mathematical functions (e.g., activation functions). On the contrary, in the present context, the processing hardware 15 used to compute the neuron outputs differs from the hardware devices 18 used to apply the subsequent mathematical functions. That being said, the processing units 18 will much preferably be “close” to the neural processing hardware 15. That is, the processing units 18 are preferably configured, in the system 1, as near-memory processing devices, as assumed in FIG. 2. Note, here, “near-memory” amounts to considering the apparatus 15 as a memory storing neuron outputs. The neuron outputs are efficiently delivered to the processing units 18, e.g., via a dedicated readout circuitry 16, which is known per se. On the contrary, in a conventional computerized system, the neuron outputs typically have to transit through conventional computer buses, be stored in the main memory (or cache) of this computerized system, and be recalled from this memory to apply the mathematical functions. I.e., a near-memory arrangement as shown in FIG. 2 differs from usual cache memory in a CPU chip.

Moreover, the processing units 18 preferably involve non-conventional computing means too, such as vector processing units (as assumed in FIG. 3), which allows computations to be further accelerated.

All the more, in the present context, the LUT is implemented in hardware, thanks to distinct hardware circuits 17, i.e., circuits that differ from each of the neural processing apparatus 15 (used to compute the neuron outputs) and the processing units 18 (used to apply the mathematical functions). So, not only the processing hardware 15, 18 may differ from conventional hardware but, in addition, a hardware-implemented LUT is relied upon (implemented by distinct circuits 17), to rapidly retrieve the parameter values and, thus, more efficiently apply the mathematical functions.

Hardware-implemented lookup table. The LUT is implemented in hardware, by way of one or more dedicated circuits 17, which can be regarded as memory circuits. Each of these circuits may implement a same table of values, or tables of values that are at least partly distinct. The circuits may also implement fully distinct tables. However, in that case, each of the distinct tables may still be regarded as a portion of a superset forming the LUT. As a whole, this table may possibly enable several types of mathematical functions.

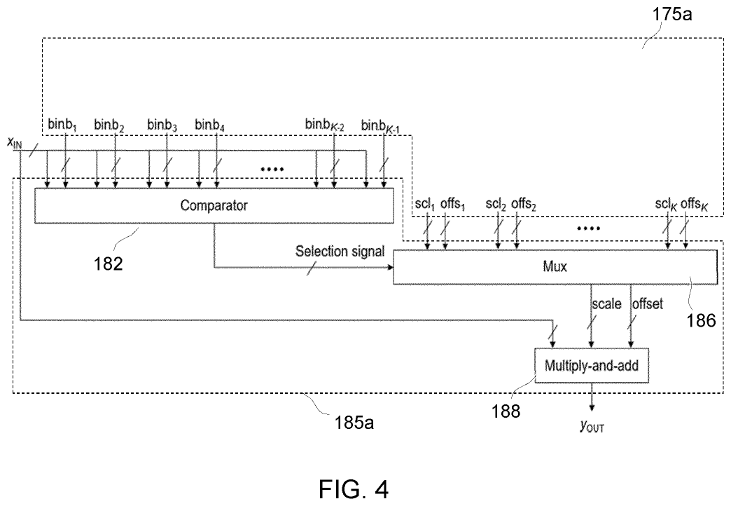

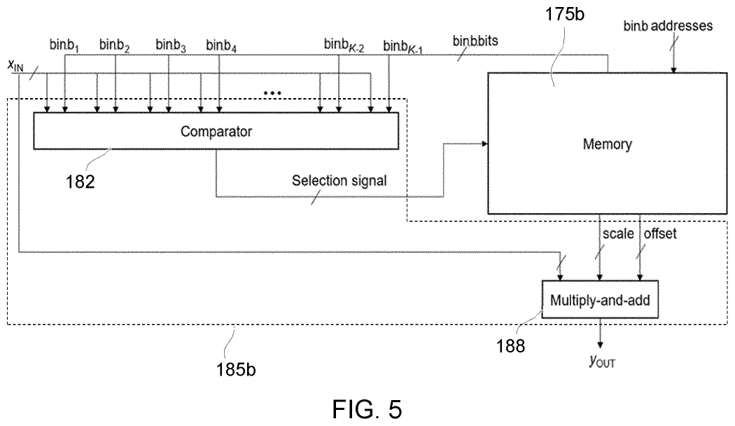

In FIG. 3, reference 17 generally refers to a set of one or more LUT circuits 175, each implementing a respective table, the values of which may possibly differ. Each circuit 175 can for instance be a circuit 175a hardcoding the parameter values or an addressable memory circuit 175b, as assumed in FIGS. 4 and 5, respectively.

In FIG. 5, the LUT is assumed to be implemented by at least one addressable memory circuit 175b storing the parameter values, it being understood that several LUT circuit 175b may be involved, e.g., as in FIG. 3, in place of the circuits 175. Note, where the LUT circuits are implemented as addressable memory circuits, the system 1 typically includes programming means (not shown) connected to the memory circuits 175b, so as to rewrite (and thereby update) the corresponding parameter values, if necessary.

In FIG. 4, the LUT is assumed to be at least partly implemented by a hardcoded circuit 175a, which is designed to provide the necessary parameter values, similar to a read-only memory (ROM) circuit. Again, several LUT circuit 175a may possibly be involved (as in FIG. 3, in place of the circuits 175). In practice, however, a hard-wired circuit can typically enable only a small number of functions. For instance, the circuit 175a shown in FIG. 4 enables a single mathematical function. Thus, it may be preferred to rely on a rewritable memory circuit, such as a random-access memory (RAM), to achieve a reprogrammable LUT, as in FIG. 5.

The examples shown in FIGS. 4 and 5 assume that one LUT circuit 175a, 175b is connected to a respective processing element 185a, 185b. However, the system 1 may actually involve several processing elements 185a, 185b, connected to one or more LUT circuits 175a, 175b. A variety of architectures can be contemplated. A minima, such architectures allow at least one LUT circuit to be mapped onto a respective processing unit 18 (or a processing element thereof), at least one at a time. That is, each processing unit 18 may possibly be dynamically connected to distinct LUT circuits, which are switched on-the-fly. Still, at least one LUT circuit should be connected to a processing unit 18 when this unit is active.

That being said, because several LUT circuits can easily be afforded (possibly in a same device) in practice, a convenient architectural option is to provide several LUT circuits 17, where at least one LUT circuit 175 is permanently connected to a respective processing unit 18, as assumed in FIG. 3. So, the LUT circuits 17 may include at least M′ distinct circuits 175, which are respectively mapped onto the M′ processing units 18. That being said, the LUT circuits may possibly include more than M′ circuits. For instance, in the example of FIG. 3, the number T of LUT circuits 175 exceeds the number M′ of processing units 18 (i.e., T>M′), to allow redundancy, and/or to be able to preload (i.e., prefetch) table values as computations proceed, if necessary, in the interest of calculation speed.

Parameter types vs. parameter values. A distinction is made between the type of parameter (e.g., a given polynomial coefficient) and the actual values (e.g., 2.173) of the parameters of each type, as retrieved from the LUT. The LUT stores parameter values of one or more types of parameters. The types of parameters may for instance correspond to polynomial coefficients, should the mathematical functions be defined as polynomials. In practice, several sets of parameters may be associated to each type of function, should the mathematical functions be defined as piecewise polynomials, as in embodiments discussed later. More generally, however, several types of mathematical functions may be involved, which functions may require different types of parameters.

Values vs. signals. The values produced by the components 15, 18 and the values retrieved from the LUT circuits 17 are encoded in respective signals. In practice, signals encoding the neuron outputs are passed from the neural processing apparatus 15 to the processing units 18 (typically via a readout circuitry 16, see FIG. 2). Computations performed by the processing units 18 further require signals to be transmitted from the LUT circuits (to retrieve the necessary parameter values). Next, further signals (encoding the second values) are passed from the processing units 18 to a neural processing apparatus, which is either the same apparatus 15 or another processing apparatus, to trigger the execution of another neural layer, and so on. This may require an input/output (I/O) unit 19, as assumed in FIG. 2. The I/O unit 19 may further be used to interface the system 1 with other machines.

Processing units, vector processing units, processing elements, and effective processors. The processing units 18 are processing circuits that are generally in the form of integrated circuits. As said, such circuits are preferably arranged as near-memory processing devices, in output of the neural processing apparatus 15, see FIG. 2, so as to efficiently process the neuron outputs.

In the present context, a processing unit 18 may include a processing element that merely requires a mere arithmetic logic unit (executing basic arithmetic and logic operations) or, even, just a multiply-and-add processing element. In variants, more sophisticated types of processing units are used, which may notably perform controlling and I/O operations too, if necessary. Such operations may else be performed by other components of the system 1, such as the I/O unit 19.

Each processing unit 18 enables at least one effective processor, thanks to at least one processing element 185, 185a, 185b. The processing units 18 may possibly be standard microprocessors. Preferably, however, the present processing units 18 are vector processing units (as assumed in FIG. 3), which allow some parallelization to be achieved when applying the mathematical functions. In the example of FIG. 3, each processing unit 18 includes a constant number b of processing elements 185, which makes it possible to efficiently operate on one-dimensional arrays of dimension b, something that can advantageously be exploited in output of the neurons. As a whole, in FIG. 3, the M′ vector processing units 18 include b M′ processing elements 185, where b denotes the degree of parallelism enabled by each vector processing unit. In principle, however, the vector processing units 18 may have distinct numbers of processing elements 185.

Conventional parallelism can further be involved, whether in variants or in addition to vector processing. That is, each unit 18 may include several cores. In fact, each processing element 185 may be a multi-core processor. So, in general, one or more processing units 18 may involve one or more processor cores, where each core may enable one or more effective processors, e.g., by way of threads dividing the physical cores into multiple virtual cores. In other words, the M′ processing units may, as a whole, give rise to M″ effective processors, where M″ is at least equal to M′ and can be strictly larger than M′.

Number of processing units (or effective processors) with respect to number of neurons. In principle, each of M′ and M″ can be larger than the number M of neurons, as explained above. This, however, may be useless in a configuration such as depicted in FIG. 2, given that at most M functions are normally needed at each algorithmic cycle performed by the neural processing apparatus 15. Thus, a preferred setting is one in which the system 1 includes M′ processing units (which may potentially involve M″ effective processors), where M≥M″>M′≥1. In variants, the system 1 has additional processing power, such that M′ (or M″) may be strictly larger than M. Such a setting may notably be useful to implement certain types of activation functions, such as concatenated rectified linear units (CReLU), which preserve both the positive and negative phase information, while enforcing non-saturated non-linearity. E.g., computing CReLU(x)=[ReLU(x), ReLU(−x)], where [.,.] denotes a concatenation, can possibly be done in separate passes. However, performance can be improved by doing this operation in a single pass, thanks to 2 M′ processing units (or 2 M″ processors). In such cases, the number of processing units (or effective processors) may advantageously be strictly larger than the number M of neurons enabled by the apparatus 15 during each algorithmic cycle.

To sum up, the number M of neurons enabled by each apparatus 15 can possibly be smaller than M′ (or M″). It can also be equal to M′, whereby each neuron output can be processed in parallel. Other configurations may involve fewer processing units (or effective processors) than neurons, i.e., M′<M and/or M″<M (assuming M>1), should one or more of the M′ processing units (or the M″ effective processors) be shared by at least some of the M neurons. The latter case reduces the number of processing units (or effective processors), causing the M artificial neurons to take turns in using the M′ processing units (or M″ effective processors).

In other words, each neuron connects to one of the M′ processing units 18 but each processing unit 18 may possibly be connected by more than one neuron. The system 1 includes at least one processing unit, which involves, a minima, a single processor (possibly a single core). However, relying on a single processor (core) might substantially impact the throughput, hence the benefit of involving several processing units or, at least, several processing cores. Conversely, vector processing is costly, hence the need of a trade-off, to optimize the number of effective processors with respect to the number of neurons.

For simplicity, the following description assumes that each processing unit 18 involves a constant number b of processing elements 185, as in FIG. 3. Moreover, each processing element 185 is assumed to give rise to a single effective processor (the processing elements do not allow virtual processing in that case), as in the examples of FIGS. 4 and 5. Thus, the total number of processing elements is equal to b M′ and the number M″ of effective processors (as effectively enabled by the vector processing units 18) is equal to the total number of processing elements (i.e., M″=b M′).

As said, it may be desired to optimize the number of effective processors with respect to the number of neurons. In that respect, the ratios of M″ to M is preferably between 1/8 and 1. Preferred architectures involve one or two vector processing units (i.e., M′=1 or 2) per neural apparatus 15, where each vector processing unit 18 involves 64 processing elements, whereby M″ is equal to 64 or 128, whereas the number M of neurons is equal to 512 in each apparatus 15. For example, use can be made of two vector processing units (M′=2), each involving 64 processing elements (b=64), such that M″ is equal to 128 and the ratio of M″ to M is equal to 1/4 in that case.

All vector processing units may possibly be directly connected to the neuron outputs (subject to readout circuitry 16), as assumed in FIG. 2. In variants, some of the vector processing units may be indirectly connected to the neurons. More precisely, part or all of the neurons may first connect to an intermediate processing unit (not shown), which itself connect to a vector processing unit. For example, where two vector processing units are used (M′=2), the first vector processing unit may directly connect to the M neurons in output of the crossbar array 15 (in fact in output of the readout circuitry 16), whereas the second vector processing unit may be connected to a so-called, depth-wise processing unit (DWPU), itself connected in output of the crossbar array 15. Inserting a DWPU allows depthwise convolution operations.

Number of LUT circuits vs. number of processing units. In principle, it is sufficient for the LUT to be implemented by a single circuit (e.g., a single addressable memory circuit) serving each processing unit 18. This, however, may require a large number of interfaces or data communication channels, should a large number of processing units be relied upon. Note, however, that where a single LUT circuit is mapped onto a single vector processing unit of b processing elements (as in FIG. 3), then a single port is required for the LUT circuit, the output signals of which can be multiplexed to the b processing elements.

One may want to be able to apply several mathematical functions. To that aim, it may be desired to connect one processing unit 18 to several LUT circuits 17. However, this will usually be useless if a single LUT circuit can already enable a large number of parameter values, which, in turn, enable multiple functions to be applied in output of the neurons. Thus, it may be sufficient to connect a single LUT circuit to a respective processing unit.

For completeness, the LUT circuits may possibly be shared by the processing units 18, instead of being shared by the processing elements 185 of each processing unit 18 (as assumed in FIG. 3). That is, the LUT circuits may possibly consist of J distinct circuits, where J<M′, this leading to configurations in which M≥M″≥M′>J≥1.

Processing units vs. mathematical functions. The number L of functions available for each processing unit 18 is larger than or equal to 1 (L≥1). Where several mathematical functions are available, any of the L functions may potentially be selected and then formed thanks to corresponding parameter values accessed from the LUT. I.e., each of the M′ processing units may potentially apply any of the available mathematical functions.

One convenient approach is to rely on a same general function construct (e.g., a piecewise-defined polynomial function), which is suitably parameterized, so that various functions can eventually be evaluated using that same construct and applied to each neuron output, as in embodiments discussed below.

Several configurations can here again be contemplated. In simple scenarios, the M′ processing units 18 apply the same function (i.e., a single function) to the outputs from every neuron of the neural layer implemented by the apparatus 15, i.e., at each algorithmic cycle. Still, distinct functions may have to be applied to outputs from successive neural layers. Conversely, in more sophisticated scenarios, the M′ processing units may implement up to M distinct functions (possibly selected from L>M potential functions) at each algorithmic cycle. In that case, distinct functions are applied to the neuron outputs. In other words, distinct functions may be used from one neural layer to the other and, if necessary, distinct functions may also be applied to neuron outputs from a same layer.

Arguments vs. parameters of the mathematical functions. In principle, the arguments are variables passed to the mathematical functions for the computation of their output values. The parameters of the function can be regarded as variables too. However, the parameters are variables that determine (i.e., contribute to fully define) the function, similar to parameters defined in a function declaration in a programming language. For example, the polynomial function ƒ(x)=αx+β has a single argument x but involves two parameters a and b, the values of which contribute to fully define the function.

Similarly, in the present context, any of the mathematical functions involved takes a value x as argument, i.e., a value encoded in a signal outputted by a neuron. Thus, any output value of this mathematical function is computed by a processing unit 18 (or a processing element) based on a value encoded in the signal obtained from the neuron connected to this unit 18 (or processing element). In FIGS. 4 and 5, the argument of the function is written x_{IN}, while y_{OUT} denotes the output value of the function. Still, in order to be able to compute the output value, parameter values must first be retrieved from the LUT, as per the present approach.

Advantages of the proposed solution. According to the proposed solution, neuron outputs are computed by dedicated neural processing hardware 15 and the mathematical functions are applied in output of the neurons, using dedicated processing means 18. The hardware implementation of the LUT accelerates the retrieval of the parameter values required to compute the mathematical function.

Such an architecture allows computations to be accelerated, not only because the components 15, 17, 18 can be individually optimized, but also because intercommunications can be enhanced. E.g., the processing units 18 can be configured as near-memory processing units 18, “close” to the apparatus 15, to accelerate the transmission of the neuron outputs, beyond the acceleration that may already be achieved by the neural processing apparatuses 15 (e.g., a crossbar array) implementing the neurons. Above all, the parameter values can be efficiently accessed by the processing units 18 from the hardware-implemented lookup table, resulting in a substantial acceleration of the computations of the function outputs. As a result, the neuron outputs can be more rapidly processed, prior to being passed to a next neuron layer.

It is important, in the present context, to understand that the LUT is not used to directly look up the function outputs (as usually done when using lookup tables) but to more efficiently access the parameter values required to evaluate the functions. This way, even a moderately-sized LUT already allows a variety of functions (e.g., non-linear activation functions, normalization functions) to be implemented. Little memory is required, given that the LUT stores parameter values instead of mapping input values to output values. Notwithstanding, the LUT may possibly be designed as a reconfigurable table, whereby the mathematical functions may be dynamically reconfigured as calculations proceed (either on training or inferencing) or updated, should new type of functions be needed over time.

Moreover, the present approach is compatible with integration, as noted earlier. That is, the LUT circuits 17, the processing units 18, and the neural processing apparatus 15, can advantageously be co-integrated in a same device. In particular, the LUT circuits 17 may be co-integrated in proximity with their respective processing units 18. The hardware system 1 may thus consist of a single device (e.g., a single chip), co-integrating all the required components. Thus, the present systems 1 may conveniently be used in a special-purpose infrastructure or network to serve multiple, concurrent client requests, as assumed in FIG. 1.

All this is now described in detail, in reference to particular embodiments of the invention. To start with, each processing unit 18 may advantageously be configured to obtain the mathematical function value (i.e., the second value) by first selecting every parameter needed, in accordance with the value outputted by the neurons (the first value) and then accordingly retrieve the corresponding parameter values. That is, operations performed to obtain the second value are based, on the one hand, on the first value and, on the other hand, on parameter values of a relevant set of parameters, as selected in accordance with the first value, where such parameter values are efficiently retrieved from the LUT. Suitable sets of parameter values can be initially determined, at build time. As one understands, this makes it possible to reduce the number of parameters required for each evaluation, in practice, because a small set of parameters already suffices to accurately estimate the function, locally, over an interval containing the input value (the first value). E.g., a linear polynomial (each requiring only two coefficients) can accurately fit a curve, locally.

In that respect, referring more specifically to FIGS. 4 and 5, each processing unit 18 may further be configured to select a relevant set of parameters by comparing the first value (the neuron output value) with bin boundaries. This makes it possible to identify a relevant bin, which contains the first value. Next, the relevant set of parameters are selected in accordance with the identified bin and then retrieved from the LUT. If necessary, a further parameter can be relied on, to select the type of function desired (e.g., ReLU, softmax, binary, etc.). The bin boundaries are stored in the LUT, along with the parameter values. Note, bin boundaries can also be regarded as parameters used to compute the functions. However, the function of such parameters differs from the parameter values (e.g., the relevant polynomial coefficients) that are used to compute the function, in fine. The bin boundaries can efficiently be retrieved too, to allow quick comparisons. The binning problem can thus be efficiently solved, which makes it possible to quickly identify the relevant set of parameters.

To that aim, each processing unit 18 preferably includes at least one comparator circuit 182 (see FIGS. 4 and 5), which is designed to compare the first value with bin boundaries. I.e., a dedicated comparator circuit is used to efficiently identify the relevant bins. As seen in FIGS. 4 and 5, the comparator circuit is further designed to transmit a selection signal encoding the selected set of parameters. Eventually, the corresponding parameter values are retrieved thanks to the transmitted selection signal. Note, a processing unit 18 may actually include more than one comparator circuit 182. E.g., processing unit 18 may include several processing elements 185 (as in FIG. 3) and such processing elements may each be designed in accordance with FIG. 4 or 5, where each element 185a, 185b includes a comparator circuit. In variants, the comparator circuits can be partly shared in the processing units.

The selection signal may notably be transmitted to a multiplexer 186, which forms part of the processing element 185a, as in FIG. 4. In variants, the selection signal is passed to the LUT circuit, e.g., an addressable memory 175b, as in FIG. 5.

More precisely, in the example of FIG. 4, the LUT circuit 175a is a circuit hardcoding parameter values. The multiplexer 186 is connected to its respective comparator circuit 182, so as to be able to receive the selection signal, in operation. The multiplexer 186 is further connected to the LUT circuit 175a, which allows the multiplexer 186 to select the relevant parameter values, in accordance with the received selection signal, in operation. Such a design makes the parameter retrieval extremely efficient. A downside is that the hardcoded data cannot be changed after hard-wiring the circuit 175a. Thus, one may prefer using a reconfigurable memory.

In that respect, the example shown in FIG. 5 depicts a LUT circuit 175b that includes an addressable memory unit 175b, which is connected to the comparator circuit 182, so as to receive the selection signal, in operation. In that case, the selection signal is directly transmitted to the memory 175b (no multiplexer is required in that case). The LUT circuit 175b is otherwise configured to retrieve the parameter values of the relevant set of selected parameters, in accordance with the received selection signal. For the rest, the comparator circuit 182 can be equivalent to the circuit used in FIG. 4. FIGS. 4 and 5 are further described in Sect. 2.

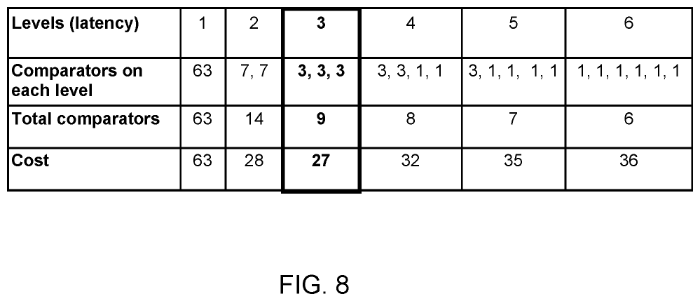

A mere binary tree comparison circuit may be relied on. However, more sophisticated comparison schemes and comparison circuit layouts can be contemplated, which enable multiple levels of comparison, to accelerate the binning. In particular, the comparator circuit 182 may advantageously be configured as a multilevel, q-ary tree comparison circuit, where q is larger than or equal to three, for one or more of the multiple levels of comparison enabled by the circuit 182, as illustrated in the table shown in FIG. 8.

In detail, in a q-ary tree comparison circuit, the number of comparator levels is equal to log_{q}(K), where K denotes the total number of bins used, assuming there are q comparators per level. Now, the number of levels, the total number of comparators, and the number of comparators in each level can be jointly optimized, as illustrated in FIG. 8. The table shows the optimal number of comparators (second row) that can be used in each level, the total number of comparators involved (third row), and the associated computational cost (fourth row). The number of levels (first row) considered in FIG. 8 varies between 1 and 6, while the number of comparators per level varies between 1 and 63 (so does the total number of comparators). The number of levels relates to latency: the larger the number of levels, the more latency. The total number of comparators induces a costs too. So, the total cost can be equated to the number of levels times the total number of comparators, as done in FIG. 8.

A q-ary tree comparison circuit enables q−1 comparators, such that the number of comparators used in each level corresponds to q−1. In principle, the optimal value of q corresponds to the floor of the number q* that minimizes the cost function (q−1)Log_{K}(q)², which accounts for the trade-off between the number of levels and the total number of comparators. Minimizing this function yields [q*]=4, corresponding to 3 comparators.

The optimal number of comparators, however, depends on the chosen cost function and the number of levels. For instance, the present inventors have performed an extensive optimization based on a more sophisticated cost function, which has led to the optimal values shown in FIG. 8. According to this optimization, best is to rely on three comparison levels and a 4-ary tree (enabling 3 comparators), where each level has a same number of comparators (i.e., 3).

As noted earlier, the applied mathematical functions will advantageously be constructed as a function defined piecewise by polynomials, where each polynomial applies to a different interval in the domain of the function. Such a function (also called a spline) is thus polynomial on each of its sub-domains, which can be mapped onto the bins. The polynomial coefficients can be adjusted to fit a given reference function (i.e., a theoretical function). Note, the polynomials do not need to be continuous across the bin boundaries in the present context (although they may be, this depending on the reference function). Thus, for any given first value (the argument of the function), a relevant set of parameters can be identified, which correspond to polynomial parameters of the locally-relevant polynomial. The corresponding parameter values are then retrieved from the LUT to estimate the output value of the function.

As one understands, using such a construct lends itself well to fast computations by an arithmetic unit. I.e., mere arithmetic operations are needed to achieve the desired result. Now, each processing unit 18 (or, in fact, each processing element 185, 185a, 185b) may include an arithmetic unit 188, which is connected to the LUT circuit 17 to perform the required arithmetic operations.

For example, an addressable memory unit may be used to store at least L×(K×(2+l)−1) parameter values, where L denotes the number of distinct functions to be implemented by the processing unit (L≥1), and/denotes the interpolation order for each interpolating polynomial (l≥1). There are K bins and K−1 bin boundaries. So, if a processing unit 18 is able to implement L functions in total, each with K bins, and implement an l-th order interpolation, then the minimal number of parameters to be stored in the memory is equal to L×(l+1)×K+L×(K−1)=L×(K×(2+l)−1).

In principle, other constructs (beyond usual splines) may be relied on. For example, the applied functions may also be B-Splines or involve Bezier Curves. However, using splines (especially linear polynomials) allows very efficient calculations to be performed. What is more, such computations can simply be performed using a multiply-and-add circuit in that case, as assumed in FIGS. 4 and 5. That is, the arithmetic unit 188 may simply consist of a multiply-and-add circuit. The circuit 188 is specifically designed to perform multiply-accumulate operations, which efficiently achieve the output value of the mathematical function. Note, up to l operations may need to be performed in that case, where/is the polynomial order. Relying on multiply-and-add circuits 188 is also advantageous to the extent that a similar (or identical) circuit technology may be used in the neural processing apparatus 15.

Indeed, the neural processing apparatus 15 preferably includes a crossbar array structure 15, i.e., a structure involving N input lines 151 and M output lines 152, where N>1 and M>1, as illustrated in FIG. 2. The input and output lines are arranged in rows and columns, which are interconnected at cross-points (i.e., junctions), via memory elements 156. Each column corresponds to a neuron, whereby the apparatus 15 can implements a layer of M neurons. Each output line 152 is connected to at least one of the M′ processing units 18. The output lines are typically connected to the processing units via a readout circuitry 16, as shown in FIG. 2. Note, each output line may possibly connect to a respective processing unit or a respective processing element. Preferably though, the M neurons partly share the processing units 18, as in FIG. 3.

The crossbar array structure 15 can be regarded as defining N×M cells 154, i.e., a repeating unit that corresponds to the intersection of a row and a column. As known per se, each row and each column may actually require a plurality of conductors. In bit-serial implementations, each cell can be connected by a single physical line, which serially feeds input signals carrying the input words. In parallel data ingestion approaches, however, parallel conductors may be used to connect to each cell. I.e., bits are injected in parallel via the parallel conductors to each of the cells.

Each cell 154 includes a respective memory system 156, consisting of at least one memory element 156, see FIG. 2. Thus, the N×M cells include N×M memory systems 156, which are individually referred to as a₁₁ to a₄₄ in FIG. 2 The memory system 156 stores weights that correspond to matrix elements used to perform the matrix-vector multiplications (MVMs). Each memory system 156 may for instance includes serially connected memory elements, which store respective bits of the weight stored in the corresponding cell; the multiply-accumulate (MAC) operations are performed in a bit-serial manner in that case. The memory elements may for instance be static random-access memory (SRAM) devices, although crossbar structure may, in principle, be equipped with various types of electronic memory devices (e.g., SRAM devices, flash cells, memristive devices, etc.). Any type of memristive devices can be contemplated, such as phase-change memory cells (PCM), resistive random-access memory (RRAM), as well as electro-chemical random-access memory (ECRAM) devices.

The memory elements may form part of a multiply-and add circuit (not shown in FIG. 2), whereby each column includes N multiply-and add circuits, so as to efficiently perform the MAC operations. Vectors are encoded as signals applied to the input lines of the crossbar array structure 15, which causes the latter to perform MVMs by way of MAC operations. Although physically limited to M neurons, the structure 15 can nevertheless be used to map larger matrix-vector multiplications, as noted earlier. If necessary, the weights can be prefetched and stored in the respective cells (in a proactive manner, e.g., thanks to multiple memory elements per cell), to accelerate the MVMs. In general, the MVMs can be performed in the digital or analogue domain. Implementations in the analogue domain can show better performance in terms of area and energy-efficiency when compared to fully digital IMCs. This, however, usually comes at the cost of a limited computational precision.

Another aspect of the invention is now described in reference to the flowchart of FIG. 6. This aspect relates to a method of operating a hardware system 1 such as described above. Essential features of this method have already been described, be it implicitly, in reference to the fist aspect of the invention. Such features are only briefly described in the following.

According to this method, operating the hardware system 1 requires operating the neural processing apparatus 15, as for instance done in steps S20 to S50 of the flow of FIG. 6. Generally speaking, operating the neural processing apparatus 15 causes to obtain M first values at each algorithmic cycle, see step S40. Such values are respectively produced by the M artificial neurons enabled by the apparatus 15. When the latter is a crossbar array structure, arrays of input values (i.e., vectors) are encoded as input signals, which are applied to input lines of the apparatus 15 to cause it to produce output signals in output of the M lines. Such output signals correspond to the first signals, as per terminologies introduced earlier.

Next, one or more mathematical functions are applied to the first values, to obtain second values. That is, an output value of a mathematical function is obtained (steps S60-S110), via the M′ processing units 18, for each first value of the M first values produced by the M neurons. As explained earlier, the mathematical function takes a first value as argument. Still, this function is otherwise determined by a set of parameters, the values of which are accessed from the hardware-implemented LUT. Thus, each mathematical function is computed based on operands that include a first value and parameter values of the set of parameters, where the parameter values are efficiently retrieved S100 from the one or more LUT circuits 17. Thus, each first value gives rise to a second value, i.e., the output value of the mathematical function. Thus, M second signals are obtained (at each algorithmic cycle), which encode M output values corresponding to evaluations of a mathematical function.

As discussed earlier, the mathematical function is preferably evaluated by first selecting S70-S80 the relevant set of parameters in accordance with the neuron output (first value). In turn, operations are performed S110 based on the first value and parameter values, which are retrieved S100 in accordance with the selected set of parameters. As further seen in FIG. 6, the set of parameters are preferably selected by comparing S70 the first value with bin boundaries to identify the relevant bin, whereby the relevant set of parameters can subsequently be selected S80 in accordance with the identified bin. This is efficiently performed, given that bin boundaries are retrieved from the LUT. Typically, several computational algorithmic cycles are performed, as illustrated in FIG. 6. Each algorithmic cycle starts with computations (i.e., the MVMs) performed by the neural processing unit 15.

A typical flow is the following. This flow relies on a hardware system 1 such as depicted in FIG. 2 to perform inferences based on an ANN, which is here assumed to have a feed-forward configuration, for simplicity. Plus, the apparatus 15 is assumed to enable a sufficiently large number M of neurons to map any layer of this ANN. The system 1 is provided at step S10; it notably includes a crossbar array structure 15, LUT circuits 17 (assumed to be programmable memory circuits), and near-memory processing units 18. The parameter values required for evaluating the mathematical function(s) are initially determined at step S5 (build time). The LUT is accordingly initialized at step S20; this amounts to programming S20 the LUT circuits for them to store adequate parameter values. If necessary, the LUT circuits may later be reprogrammed to update the functions. Aside from the LUT circuits 17, the matrix coefficients (i.e., weights) have to be initialized in the crossbar array 15 to configure S30 it as a first neural layer of the ANN to execute.

Next, the input unit 11 of the system 1 applies S40 a currently selected input vector to the crossbar array 15 for it to perform MVMs. Signals are obtained in output of the M columns of the crossbar 15. The obtained signals encode the neuron output values (or first values). The corresponding values are read out by a dedicated circuitry 16 and passed S60 to the processing units 18. Comparator circuits of the units 18 compare S70 the neuron output values with bin boundaries to identify the relevant bins. Corresponding selection signals are then forwarded S80 by the comparator circuits to the LUT circuits to retrieve S100 the relevant parameter values from the LUT. This makes it possible to efficiently compute S110 output values of one or more mathematical functions (such as activation functions), something that is preferably performed thanks to multiply-and-add circuits 188.

The process repeats for each successive layer. If the current neural layer is the last layer (S120: Yes), then the algorithm may return S130 the last function values with a view to forming an inference result. Else (S120: No), the function values obtained at step S110 can be passed S140 to a further processing unit (e.g., a digital processing unit), if necessary. That is, the outcome of step S110 may possibly have to be passed to a digital processing unit that performs S140 operations that cannot be implemented by the crossbar array 15 or the processing units 18. For example, a digital processing unit may be involved to perform a max pooling operation. The values obtained in output of step S110 (or S140) are then sent S150 to the input unit of the same crossbar array 15 or another, cascaded crossbar array 15. That is, a next input vector is formed and another algorithmic cycle S40-S150 is started. Note, in parallel to steps S60-S140, new matrix coefficients may be stored S50 in the (next) crossbar array to configure it as the next neural layer.

The mathematical functions involved are preferably built as piecewise-defined polynomial functions, for reasons mentioned earlier. In that case, each set of parameters includes two or more polynomial coefficients, and the required operations can merely be performed S110 as arithmetic operations. This is efficiently done thanks to a multiply-and-add circuit 188, something that makes it possible to re-use the same technology as used for the neural processing apparatus 15.

For example, each mathematical function may be evaluated, over a range of interest, using a set of linear polynomials, each mapped onto a respective bin. Where linear polynomials are used, the respective sets of parameters may consist, each, of a scale coefficient and an offset coefficient (though polynomials may be defined in different ways).

The degree of the polynomials used may be chosen at step S5. This preliminary step S5 may further include the determination of suitable sets of bin boundaries, together with corresponding parameter values, for respective reference functions, i.e., functions of potential interest for ANNs. Various methods can be contemplated. In general, the determination of suitable bin boundaries can be regarded as an optimization problem. Adequate bin boundaries are typically determined S5 (for each reference function) by minimizing the number of bins (given a maximal error tolerated at any point) or a maximal error between approximate values of the reference function (as computed based on parameter values) and theoretical values of the reference function, given a pre-determined number of bins to be used. A joint optimization may possibly be performed too, so as to optimize for both the number of bins and the maximal error. Detailed explanations and examples are provided in Sect. 2.

Various types of reference mathematical functions can be considered, irrespective of the constructs used to estimate them. The LUT circuits 17 may enable a variety of mathematical functions as routinely needed in ANN computations, such as activation functions, normalization functions, reduction functions, state-update functions, as well as analytical classification, prediction, or other inference-like functions.

Activation functions are an important class of functions, as such functions are mostly required to be applied to the neuron outputs. In particular, non-linear activation functions may be used, such as the so-called Binary Step, Sigmoid, Tanh, ReLU, Leaky ReLU, and Softmax (i.e., normalized exponential) functions. Specific normalization functions may be needed too (e.g., batch normalization, layer normalization). Furthermore, as noted earlier, the applied mathematical function may be any analytical function used to perform inferences (classifications, predictions). In certain cases, however, the mathematical function may be bypassed or configured as the identity function.

The parameter values retrieved from the LUT will often be sufficient for the processing units 18 to compute the full function output. However, in other cases, additional (external) processing may be needed, e.g., to compute the sum of exponents required in a softmax function. In addition, other types of operations may sometimes have to be performed, such as a reduction operations on a set of values, or arithmetic operations between such values. For completeness, the LUT may also store values that may be used by the system 1 to perform other tasks, such as tasks of support vector machine algorithms.

The above embodiments have been succinctly described in reference to the accompanying drawings and may accommodate a number of variants. Several combinations of the above features may be contemplated. Examples are given in the next section.

### 2. Specific Embodiments—Technical Implementation Details

### 2.1 Bin Boundaries Determination and Interpolation

The LUT preferably implements a piecewise polynomial function such that, given an input value x, a vector of bin boundaries b_{b} and a vector c of coefficients, the output o of the function is generally calculated as o=ƒ(x, c[i]), where i is an integer such that x>b_{b}[i−1], x≤b_{b}[i]. A suitable methodology for creating the LUT values should ideally allow a simple definition of the parameters used to calculate the desired function. Moreover, this methodology should advantageously support different types of approximations to the function.

The following describes several methods that can be applied to approximate the function as piecewise polynomial (spline). In the simplest case, the interpolation is linear, and the function is defined by two parameters, a scale and an offset coefficient.

FIGS. 7A-7C illustrates a method for binning with linear interpolation for the GELU function. The plain (continuous) line represents the reference function, while the thick (striped) curve represents the interpolated version, as approximated using pre-determined parameter values. The thick points represent optimal boundaries of the bins.

The following examples of methodology differ mainly in the way the bins are obtained. They have in common that they all attempt to minimize the error between a function and its interpolated version. However, they differ in the way this minimization is performed. Some of the proposed approaches attempt to minimize the number of bins given the maximum error at any point, while others seek to minimize the error given the number of bins to be used.

For example, the following method minimizes the number of bins given the maximum error at any point. The underlying algorithm proceeds as follows:
(i) An interval of interest of the mathematical function is defined by the user. A pointer is assigned, which points to this interval;
(ii) An interpolation of the points defining the limits of the interval(s) is subsequently performed;
(iii) The error between the value of the original function and the value of the interpolated curve at the centre of the interval (as pointed to by the pointer) is then computed;
(iv) If the error is greater than or equal to a user-defined tolerance, then the pointed interval is split in half and the pointer is moved to the left interval after splitting. Else, the pointer is moved to the next interval on the right. Once there are no more intervals to the right, the algorithm stops, else it goes back to step (ii).

Comments are in order. For symmetric and antisymmetric functions, the algorithm is applied to the part of the function at the left or right of the axis of symmetry or anti-symmetry, and the values of the bins are calculated by mirroring the bins according to the symmetry/anti-symmetry pattern. Heuristics may be relied on to automatically determine the limits of the interval of interest. The interval of interest may also be initially divided into a fixed number of equally spaced bins; in that case the above algorithm may be applied to each of the initial bin boundaries.

Assuming that a linear interpolation is desired, each linear portion requires a slope coefficient (slp) and an offset coefficient (off). Then, a particular output o of the function on a particular subdomain corresponding to a given input x can be estimated as o=slp[i]×x+off[i], where i denotes an integer corresponding to the input x, e.g., determined as i|x>b_{b}[i−1]; x≤b_{b}[i], where b_{b} again denotes the bin boundary vector.

Let us illustrate the above binning approach with an example, in which the gaussian error linear unit (GELU) function is to be approximated, see FIG. 7A. Initially, a number nᵢ of points are determined (or inferred), FIG. 7A, where nᵢ≥2. Such points delimit nᵢ+1 intervals. Assume that only two points are initially determined, for simplicity. Bins are only necessary between the nonlinear parts of the function. So, the algorithm may first determine the interval(s) in which the function is nonlinear. This gives rise to a single interval in the example of FIG. 7A. The next step consists of binning within the nonlinear region only. To that aim, the algorithm can measure the error at the centre of the bin and then split this interval in two equal sub-intervals if the error exceeds a tolerance. This is illustrated in FIG. 7B, which shows an additional point. The same operation can then be repeated until a suitable number of intervals are achieved, which result in acceptable interpolation errors. Eventually, each interval is assigned a triplet of optimal parameter values. E.g., the first interval corresponds to b_{b}[0], slp[0], and off[0], the second interval corresponds to b_{b}[1], slp[1], and off[1], and so on. Each set of parameter values is stored in the LUT, so as to be later retrieved at runtime.

Another approach is to minimize the number of bins used given the maximum error (Eₘₐₓ) at any point (an optimization constraint). The algorithm proceeds as follows:
(i) The interval of interest of the function is again defined by the user;
(ii) The algorithm starts from one boundary (either left or right) of the interval of interest and considers it as one of the boundaries of the first bin. The following assumes the left boundary as a starting point. In this case, the left boundary of the interval of interest is also the left boundary of the first bin. The initial value (defined via delta) of the other bin boundary (the right bin boundary in this case) is imposed by the user;
(iii) The linear interpolation of the points in the bin is chosen so that the maximum error between the interpolation function and the function to be interpolated in the given bin (E_{bin_max}) is at its left and right boundary as well as in the middle on the bin (just of the opposite sign). This can be achieved by interpolating the points defining the boundaries of the bin. Then this line is shifted by half of the error in the middle of the bin, which is equal to E_{bin_max};
(iv) If E_{bin_max}<Eₘₐₓ, the bin is increased (by moving its right boundary to the right) by the initial value of the bin (delta) and step (iii) is repeated to determine the new E_{bin_max}. Step (iv) is then repeated until E_{bin_max}≥Eₘₐₓ when proceeding to the next step (step (v));
(v) The algorithm checks if |Eₘₐₓ−E_{bin_max}|<epsilon, where epsilon is user-defined. If so, the algorithm proceeds to step (vi). Else, it moves the right boundary to the left by delta/2 and step (iii) is repeated to determine the new E_{bin_max}. Step (v) is then repeated, each time by halving the interval for which the boundary is moved, and in the direction determined by the sign of Eₘₐₓ−E_{bin_max} (if positive to the right, else to the left) until the condition |Eₘₐₓ−E_{bin_max}|<epsilon is true. Then, the algorithm proceeds to step (vi);
(vi) The algorithm then repeats the same procedure for the next bin, starting at step (ii); and
(vii) The algorithm continues until all bins are definitive. Eventually, the function can be estimated by interpolation, in accordance with parameter values obtained for each of the bins.

Note, further methods can be used to find the bin size verifying |Eₘₐₓ−E_{bin_max}|<epsilon in steps (iv) and (v). In addition, the limits of the interval of interest can also be computed automatically using heuristics.

Various other algorithms can be contemplated. For example, a non-iterative variant of the above algorithm may be devised, which determines the bins in a single step. This variant minimizes the error given the number of bins to be used and can involve any interpolation polynomial. Given a desired number of bins, and the degree d of the interpolation polynomial, this algorithm approximates the d^{th} derivative of the function. The optimal size of each bin is inversely proportional to the rate of change of the highest degree coefficient and accordingly to the rate of change of the d^{th} derivative of the function, which actually is (d+1)^{th} derivative of the function. A cumulative sum of (d+1)^{th} derivative of the function is calculated in a number of sampling points (much larger than number of bins), based on which optimal bins are identified.

Further approaches may be based on neural networks, trained to minimize either the number of bins or the maximum error in each bin.

### 2.2 Preferred Hardware Implementation

The following describes a hardware implementation that assumes a linear interpolation. Two classes of embodiments can be contemplated in this case. The first class concerns fixed (predefined) function implementations, where K−1 bin boundaries are used, together with K scaling coefficients and K offset coefficients. Such numbers remain constant at run time. The typically small number of required coefficients does not require an addressable memory and can instead be hardcoded (FIG. 4) in a LUT circuit 175a, similar to a ROM circuit. A priority network of comparators 182 provides selection signals, which are fed to the multiplexer 186; The latter can accordingly select the optimal scale and offset parameter values. The multiply-and-add unit 188 can for instance be implemented as two separate units (for multiplication and addition) or a fused multiply-add unit. The values bin·bᵢ (where 1≤i≤K−1) refer to optimal bin boundaries values (corresponding to optimal vector components b_{b}[i], see the previous subsection), which are hardcoded in the circuit 174a. For completeness, sclᵢ and offsᵢ refer to scale and offset coefficients, also hardcoded in the circuit 174a.

Conversely, where an arbitrary function implementation is desired, use can be made of an addressable memory storing all required bin boundaries, as well as the scaling and offset coefficients, as assumed in FIG. 5. This memory can be reprogrammed. Such embodiments again involve a priority network 182 of comparators and a multiply-and-add unit 188, as in FIG. 4. However, an addressable memory 175b is used for storing the bin boundaries, as well as the scale and offset coefficients, for every desired functions. In that case, the memory also provides selection of the optimal scale and offset parameter values, through its output decoder. The values bin·bᵢ, sclᵢ, and offsᵢ, refer to bin boundaries values, scale coefficients, and offset coefficients, as in FIG. 4. However, an additional value (“bin·b·bits”) is needed in that case, which corresponds to (K−1) times the number of bits used to store a bin boundary. In addition, addresses (bin·b·addresses) of the bin boundaries must be passed to the memory for it to retrieve the corresponding values.

The circuit 175a and the memory unit 175b shown in FIGS. 4 and 5 can be mapped to processing elements 185 as shown in FIG. 3. The neural processing apparatus 15 is preferably embodied as a crossbar array 15 (FIG. 2). All components and devices required in the system 1 are preferably co-integrated on a same chip, as assumed in FIG. 2. So, the system 1 may be assembled in a single device, including a crossbar array structure 15, LUT circuits 17, and processing units 18, where the processing units 18 are preferably arranged as near-memory processing units. In addition, the device 1 may include an input unit 11 to apply input signals encoding the input vector components to the crossbar array 15. Furthermore, the device 1 typically involves a readout circuitry 16, as well as an I/O unit 19 to interface the system 1 with external computers (not shown in FIG. 2).

FIG. 1 illustrates a network 5 involving several systems 1 (e.g., integrated devices such as shown in FIG. 2). That is, the systems 1 form part of a larger computer system 5, involving a server 2, which interacts with clients 4, who may be natural persons (interacting via personal computers 3), processes, or machines. Each hardware system 1 is configured to read data from, and write data to, the memory unit of the server computer 2 in this example. Client requests are managed by the unit 2, which may notably be configured to map a given computing task onto vectors and weights, which are then passed to the systems 1. The overall computer system 5 may for instance be configured as a composable disaggregated infrastructure, which may further include other hardware acceleration devices, e.g., application-specific integrated circuits (ASICs) and/or field-programmable gate arrays (FPGAs).

Of course, many other architectures can be contemplated. For example, the present system 1 may be configured as a standalone system or as a computerized system connected to one or more general-purpose computers. The system 1 may notably be used in a distributed computing system, such as an edge computing system.

### 3. Final Remarks

Computerized devices and systems 1 can be designed for implementing embodiments of the present invention as described herein, including methods. In that respect, it can be appreciated that the methods described herein are essentially non-interactive, i.e., automated. Automated parts of such methods can be implemented in hardware only, or as a combination of hardware and software. In exemplary embodiments, automated parts of the methods described herein are implemented in software, as a service or an executable program (e.g., an application), the latter executed by suitable digital processing devices. However, all embodiments described herein involve computational steps that are performed thanks to non-conventional hardware such as hardware-implemented LUTs, neural processing apparatuses such as crossbar array structures, and separate processing units, preferably arranged as near-memory processing units with respect to the neural processing apparatus.

Still, the methods described herein may further involve executable programs, scripts, or, more generally, any form of executable instructions. The required computer readable program instructions can for instance be downloaded to processing elements from a computer readable storage medium, via a network, for example, the Internet.

Aspects of the present invention are described herein notably with reference to a flowchart and block diagrams. It will be understood that each block, or combinations of blocks, of the flowchart and the block diagrams can be implemented thanks to computer readable program instructions. The flowchart and the block diagram in the accompanying drawings illustrate the architecture, functionality, and operation of possible implementations of the systems 1, methods of operating them, according to various embodiments of the present invention.

While the present invention has been described with reference to a limited number of embodiments, variants, and the accompanying drawings, it will be understood by those skilled in the art that various changes may be made, and equivalents may be substituted without departing from the scope of the present invention. In particular, a feature (device-like or method-like) recited in a given embodiment, variant or shown in a drawing may be combined with or replace another feature in another embodiment, variant, or drawing, without departing from the scope of the present invention. Various combinations of the features described in respect of any of the above embodiments or variants may accordingly be contemplated, that remain within the scope of the appended claims. In addition, many minor modifications may be made to adapt a particular situation or material to the teachings of the present invention without departing from its scope. Therefore, it is intended that the present invention is not limited to the particular embodiments disclosed, but that the present invention will include all embodiments falling within the scope of the appended claims. In addition, many other variants than explicitly touched above can be contemplated. For example, other types of memory elements devices, selection circuits, LUT circuits, and processing units can be contemplated.

1. A hardware system designed to implement an artificial neural network, the system comprising:
a neural processing apparatus configured to implement M artificial neurons, where M≥1;
one or more lookup table circuits configured to implement a lookup table; and
M′ processing units, where M≥M′≥1, wherein each processing unit of the M′ processing units is
connected by at least one neuron of the M artificial neurons to access a first value outputted by each neuron of said at least one neuron,
connected to a lookup table circuit of the one or more lookup table circuits to access parameter values of a set of parameters from the lookup table, and
configured to output a second value corresponding to a value of a mathematical function taking said first value as argument, the mathematical function determined by the set of parameters, the parameter values of which are accessed by said each processing unit from said lookup table circuit, in operation.

2. The hardware system according to claim 1, wherein said each processing unit is configured to output the second value by:
selecting said set of parameters in accordance with said first value, and
performing operations based on said first value and the parameter values of the selected set of parameters, with a view to outputting said second value.

3. The hardware system according to claim 2, wherein said each processing unit is further configured to
to access bin boundaries of bins from said lookup table circuit, and
select said set of parameters by comparing said first value with the accessed bin boundaries to identify a given bin of the bins that contains said first value, whereby the set of parameters are selected in accordance with the given bin, in operation.

4. The hardware system according to claim 3, wherein
said each processing unit includes at least one comparator circuit that is designed to
compare said first value with said bin boundaries, and
transmit a selection signal encoding the selected set of parameters for said processing unit to access the corresponding parameter values based on the transmitted signal.

5. The hardware system according to claim 4, wherein
the comparator circuit is configured as a multilevel, q-ary tree comparison circuit designed to enable multiple levels of comparison, where q is larger than or equal to three for one or more of the multiple levels.

6. The hardware system according to claim 4, wherein
said lookup table circuit is a circuit hardcoding parameter values, and
said each processing unit includes at least one multiplexer, which is connected to
a respective one of said at least one comparator circuit to receive said selection signal and
said lookup table circuit to retrieve the corresponding parameter values in accordance with said selection signal.

7. The hardware system according to claim 4, wherein
said lookup table circuit includes an addressable memory unit, which is
connected to said comparator circuit to receive said selection signal and
configured to retrieve the parameter values of the set of selected parameters in accordance with the received selection signal.

8. The hardware system according to claim 4, wherein
the mathematical function is a piecewise-defined polynomial function, which is polynomial on each of its sub-domains, the latter respectively corresponding to the bins,
the selected set of parameters correspond to polynomial parameters of the piecewise-defined polynomial function, and
said each processing unit includes an arithmetic unit, which is connected in output of said lookup table circuit and is designed to perform said operations to compute the second value as arithmetic operations.

9. (canceled)

10. The hardware system according to claim 1, wherein
the one or more lookup table circuits include M′ distinct circuits, which are respectively mapped onto the M′ processing units, where M≥M′>1.

11. The hardware system according to claim 1, wherein
the neural processing apparatus includes a crossbar array structure including N input lines and M output lines arranged in rows and columns, where N>1 and M>1, so as for the neural processing apparatus to implement a layer of M neurons,
the input lines and output lines are interconnected via memory elements, and
each of the M output lines is connected to at least one of the M′ processing units.

12. The hardware system according to claim 1, wherein
the one or more lookup table circuits, the processing units, and the neural processing apparatus, are co-integrated in a same chip.

13. The hardware system according to claim 1 wherein
M>1,
M′=1 or 2, and
each of the M′ processing units is a vector processing unit including b processing elements, to operate on a one-dimensional array of dimension b.

14. A method of operating a hardware system, the method comprising:
providing the hardware system, which includes
a neural processing apparatus configured to implement M artificial neurons, where M≥1,
M′ processing units, each connected by at least one neuron of the M artificial neurons, and
one or more lookup table circuits implementing a lookup table;
operating the neural processing apparatus to obtain M first values produced by the M artificial neurons, respectively; and
via the M′ processing units, obtaining, for each first value of the M first values, an output value of a mathematical function that takes said first value as argument and is otherwise determined by a set of parameters, based on operands that include said first value and parameter values of said set of parameters, where the parameter values are retrieved from the one or more lookup table circuits.

15. The method according to claim 14, wherein the output value is obtained, for said each first value, by
selecting said set of parameters in accordance with said first value, and
performing operations based on said first value and the parameter values retrieved in accordance with the selected set of parameters.

16. The method according to claim 15, wherein said set of parameters are selected by
comparing said first value with bin boundaries of bins to identify a given bin of said bins that contains said first value, wherein the bin boundaries are retrieved from the one or more lookup table circuits; and
selecting the set of parameters in accordance with the given bin identified.

17. The method according to claim 16, wherein the method further comprises, prior to operating the neural processing apparatus,
determining one or more sets of bin boundaries, in accordance with one or more reference functions, respectively.

18. The method according to claim 17, wherein
the bin boundaries of each of the sets are determined for each reference function of the one or more reference functions, so as to minimize a number of the bins or a maximal error between approximate values of said each reference function as computed based on parameter values and theoretical values of the reference function.

19. The method according to claim 16, wherein
the mathematical function is a piecewise-defined polynomial function,
the set of parameters includes two or more polynomial coefficients, and
the performed operations consist of arithmetic operations.

20. The method according to claim 19, wherein
the mathematical function includes a set of linear polynomials, each corresponding to a respective one of the bins, and
the set of parameters corresponding to each of the linear polynomials consists of a scale coefficient and an offset coefficient.

21. (canceled)

22. The method according to claim 14, wherein the method further comprises
programming the one or more lookup table circuits implementing the lookup tables to enable the mathematical function as one of
an activation function,
a normalization function,
a reduction function,
a state-update function,
a classification function, and
a prediction function.
